(19) United States
(12) Patent Application Publication
(10) Pub. No.: US 2007/0067638 A1
(43) Pub. Date: Mar. 22, 2007

(54) Method of Session Consolidation

(76) Inventors: Roland Haibl, Kammlach (DE); Siegfried Heinkele, Grafenau (DE); Juergen Holtz, Pleidelsheim (DE); Walter Schueppen, Boeblingen (DE)

Correspondence Address: IBM CORPORATION;INTELLECTUAL PROPERTY LAW, 11400 BURNET ROAD, AUSTIN, TX, 78758, US

(21) Appl. No.: 11/419,063

(22) Filed: May 18, 2006

(30) Foreign Application Priority Data
Sep. 22, 2005 (EP) 05108752.6

(51) Int. Cl. H04L 9/00

(52) U.S. Cl. 713/182

(57) ABSTRACT

The present invention relates to a method and system for managing client-server communication in an electronic network, wherein for multiple clients a client authentication and authorization is required for accessing server applications. In order to provide an increased flexibility in the user administration and reduced server-side efforts therefore, it is proposed to perform the following steps:
a) managing the client authentication data of a plurality of clients and authorization data for authorized accesses to said server applications in a session control component (20) independent of said server applications, b) receiving incoming client requests directed to access one of said server applications, c) checking the authentication and/or authorization of said client requests,
d) maintaining (540) a single Proxy-user in relation to a single server application, wherein said Proxy user represents a plurality of clients and their authorization for connecting to and for using said respective single server application, e) operating a single session using said Proxy-user for a plurality of allowed client requests directed to an access to a respective same single server application, f) processing said requests sequentially within said single session.

### 1. BACKGROUND OF THE INVENTION

1.1. Field of the Invention

The present invention relates to a method and system for managing client-server communication in an electronic network, wherein for multiple clients a client authentication and authorization is required for accessing server applications.

1.2. Description and Disadvantages of Prior Art

A typical prior art system architecture is given in FIG. 1A. Multiple clients 1 . . . n communicate with multiple server applications 1 . . . m. For each communication a respective single session is used which is built and managed individually between each client and each server application.

A session is to be understood for the purpose of the present invention as a communication task between a client and a server application.

A session is created by the client requesting service from a particular server application. The client uses operating system services to address this server application and to communicate according to the protocols supported by both. A session remains active until it is explicitly terminated by the client, the server application, or as a result of failure within the communication layer.

The term “server” is hereby understood to comprise the hardware of a computer system which acts in serving any service to a requesting client as well as a piece of software installed on a hardware which does the same. Thus, either hardware or software or a combination of hardware and software is included by this term.

The terms “user” and “client” are used in a synonymous way and in the usual sense for the service requesting unit.

Each session needs the management of user authentication and user authorisation for accessing the resources managed by a respective server application. In order to do that a user is provided with a user ID and a password for authentication purposes and is provided with specific access rights providing a user to access some specific server application resources. Those resources can for example be certain database tables if a server application manages a database or they comprise write or read access to certain file system structures by which an authorisation for some operation (e.g. read, write, delete, create, etc.) is defined. In this prior art system architecture the user authentication and user authorisation requires a quite high degree of management and binds a respective large amount of resources.

If the number of clients n is high the session administration work is unacceptably high.

A further prior art approach is the so-called “session-pooling” which is done in particular for database applications.

Session-pooling addresses the problem of sometimes time-consuming procedures to establish a communication session between a client and a server application, in particular in database environments by caching sessions established once.

Session-pooling stores the session for a user temporarily over a predefined time, even if the user has performed a logoff for terminating a session. If the same user wants to reconnect to a specific server application with which he communicated in a preceding session, such session-pooling architecture enables for recovering the precedingly used session without requiring establishing a new session. This is done as long as this preceding session remains stored in a cache memory. If the session is already deleted from the cache a new session has to be built up. The disadvantage is that the pool size is limited and after a certain predefined time is elapsed or other rules are fulfilled, a session must be deleted and is no more available for another use by the same client. Session-pooling alone still results in a dedicated session between one particular client and the server application.

In database environments, the concept of a so-called “technical user” exists as schematically depicted in FIG. 1B, on whose behalf n clients can create a session to a particular database. Such concept is for example published at:

http://www.travdis.ch/Images/RLSmitDotNet_en_tcm9-3433.pdf.

The definitions required to administer database access for these n clients are therefore limited to just the technical user. The drawback with this prior-art concept is that specific database interactions such as INSERT or DELETE are still done by the client itself. There is no administrational benefit beyond the mere session creation itself as each client's rights have to be administrated on the server side.

1.3. Objectives of the Invention

It is thus an objective of the present invention to provide a method and system for managing client-server communication in an electronic network according to the preamble of claim 1, which provides an increased flexibility in the user administration and reduced server-side efforts therefore.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to the broadest aspect of the invention a method for managing client-server communication in an electronic network is disclosed, wherein for multiple clients a respective client-related authentication and authorization is required for accessing server applications, which is characterized by the steps of:

a) managing the client authentication data of a plurality of clients and authorization data for authorized accesses to said server applications—preferably in a session control component—independent of said server applications,

b) receiving incoming client requests directed to access one of said server applications, which is implemented preferably either

b1) directly by passing all information required to establish a session along with the request, or

b2) indirectly by passing a reference to a session object containing said information,

c) checking the authentication and/or authorization of said client requests,

d) maintaining a single Proxy-user in relation to a single server application who represents a plurality of clients and their authorization to connect to and use the respective single server application,

e) operating a single session using said Proxy-user for a plurality of allowed client requests directed to an access to a respective same single server application,

f) processing said requests sequentially within said single session.

A proxy user is to be understood in here as a component of the communication system which is interposed between “original client” and “original server”. Its appearance and characteristics do not differ from that of any other user with the exception that it represents a plurality of real users.

The above-step a) thus means to concentrate the work necessary for the user administration and session administration in a control component and to do the user authentication and authorisation work independently of the server applications within the control component or within a separate software as told by the control component. This session control software then preferably provides a single proxy user functionality which is visible to a server application. This principle is preferably followed for each server application. Thus, each server application is related to and communicates with a client using a respective consolidated session. This is done preferably with a respective software portion provided within the session control component.

This principle allows performing a kind of “consolidated” application server sessions. At least one session must be implemented per server application. Of course, if the traffic thus requires, a plurality of sessions can be established to one specific server application. As one consolidated session comprises the administration of a quite large plurality of users (which is a question of an individual setting) in effect, a very large quantity of users can be connected to a specific single server application.

The plurality of clients participating in a single consolidated session is processed sequentially, which can be implemented for example in a queue.

As a person skilled in the art may appreciate the administrative overhead is limited to one or a respective small number of proxy user IDs that access the server application. Further, the resource requirements, for example tasks and network resources are limited to what a single session requires, and the programming requirements are kept at a minimum because they merely need to refer to a single consolidated session (or if really necessary a small number of them) rather than to a large plurality of them in case of prior art multiple sessions, wherein a session is defined between each client and each server application separately.

Further, this basic principle is open to be extended in a way that a single client has the flexibility to create multiple sessions, if for example different session characteristics are desired, for example due to different security aspects.

When said single Proxy-user functionality is implemented by generating a logical session proxy part representing a plurality of N session objects, and a physical session proxy part associated therewith and running a session control instance which performs the requested server application accesses with respective resources—processes, tasks, threads, etc—provided by the Operating System of the hardware implementing the session control component, then the advantage results that the logical Proxy part can remain untouched if the physical part gets damaged, e.g., by a communication failure. Thus, only the physical part must be recovered in this case.

The session control component can reside on the same hardware which hosts one or more server applications, or it can be implemented stand-alone and connected by network facilities, or—less probable—it may reside at each of the client systems.

Further, a consolidated session can be defined such that the communication channel provided therewith has a specific bandwidth. Thus, in case a plurality of consolidated sessions is defined, communication channels can be established having different bandwidths, which is a means in the intentional concept for adapting the required bandwidth.

Further, advantageously when session objects are defined which comprise the individual control parameters in a client request, then symbolic, self-explaining names can be provided for such session object and thus covering the non-selfexplanatory, “difficult-to-understand”-names of server IDs or server application IDs to the user. By an additional mapping of the symbolic names to such respective server IDs or server application IDs a unique mapping relation can be defined and looked up by the session control component when forwarding the request to the correct server application. Concurrently, a user is no more confronted with such difficult names and terms, i.e. a user concentrates on ‘what’ needs to be accomplished rather than ‘how’ it can be accomplished.

### 3. BRIEF DESCRIPTION OF THE DRAWINGS

The present invention is illustrated by way of example and is not limited by the shape of the figures of the drawings in which:

FIGS. 1A and B are each a schematic block diagram representation of a prior art client server interconnection established by individual sessions between each client and each server (n times m sessions);

FIG. 2 is a schematic block diagram representation of a system architecture according to a preferred embodiment of the present invention illustrating a consolidated session between the session control component and a respective server application;

FIG. 3 is a schematic depiction of the components relevant for session management;

FIG. 4 is a schematic depiction showing some implementational aspects of an inventional session control instance;

FIGS. 5A and 5B are control flow diagrams illustrating steps of the inventional method in a preferred embodiment thereof;

FIG. 6 is a schematic depiction illustrating session implementation details, and

FIG. 7 is a schematic depiction of the mapping between client requests to sessions according to the invention.

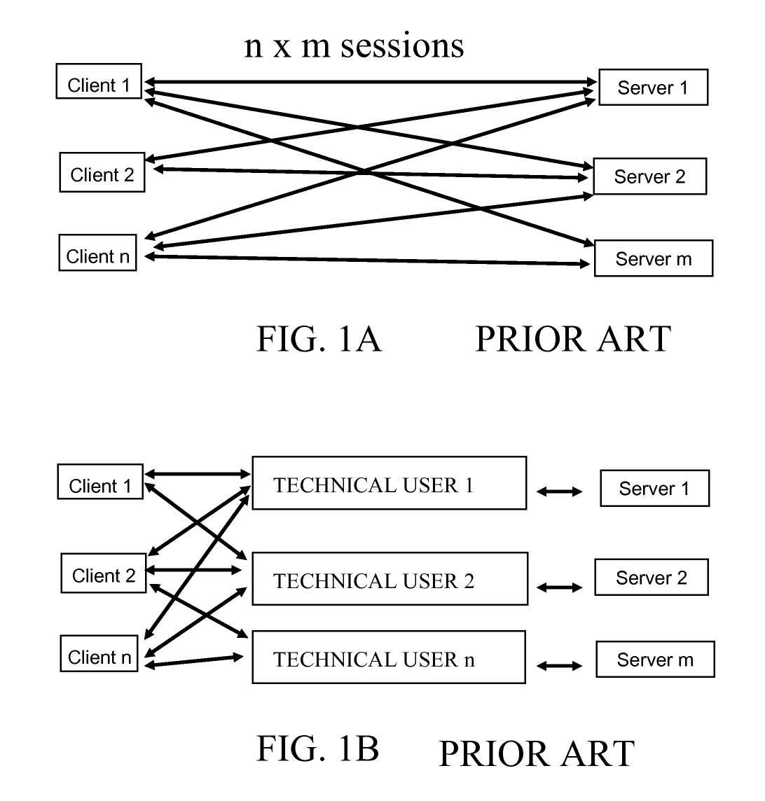

### 4. DETAILED DESCRIPTION OF THE PREFERRED EMBODIMENT

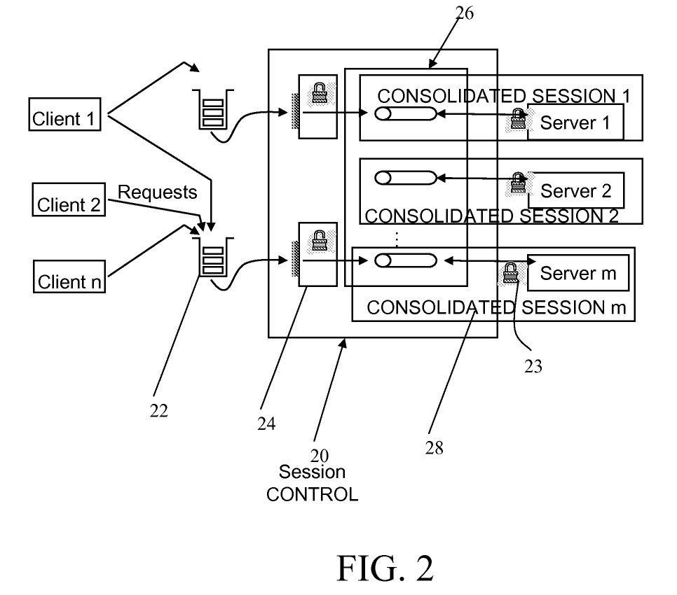

With general reference to the figures and with special reference now to FIG. 2 a plurality of clients depicted left put some requests to server applications depicted right in the drawing. More particularly, a session control component 20 is provided according to the invention for setting up and operating (and terminating) a consolidated session 28 to each of the server applications depicted right.

In order to do that the incoming requests for a specific server application are queued in a queue 22 provided per consolidated session. The queue 22 issues serialised requests to an access authorisation management component 24. This component 24 is connected between queue 22 and a session creation/deletion component 26. Component 24 checks for an incoming request the user ID and password of the requesting person or if a different request ID is allowed, in case the requestor is not a human person but instead an automated program component.

Further, the access authorisation management component 24 checks which requests are allowed for a particular requesting client at a particular, respective server application. For example component 24 rejects a deletion request for a certain database field, if the requesting user is a human person which has no write access for the respective database table.

After performing the check procedures a request is either rejected or forwarded to the session creation/deletion component 26 which maps the request to a particular session 28 provided for the requested server application and along with this also maps the request to a particular proxy-user associated with this session. The proxy-user appears within the described system as any other ordinary user but it represents a plurality of ‘real’ users and their entitlements related to the requested server application.

The session creation/deletion component 26 is able to manage a required number of sessions dynamically depending of the current need. Thus, sessions are created automatically by this component if incoming requests require a connection to a server for which no consolidated session is yet established. Further, sessions can be created automatically by this component and offered to a client for manual or programmed entering, if the number of incoming requests requires a bandwidth exceeding the bandwidth which is defined for an already existing consolidated session for a specific server application. Whenever a session is created, the connection to said session is done via the proxy-user.

Each request/response pair uses the consolidated session exclusively for the duration of the request. The consolidated session 28 created by component 26 is thus a session, which processes the client requests in a serialised form. This also applies for server application responses, if they are implied by a specific request. Thus, the session is a bidirectional communication channel between session control component 20 and a respective server application. If a request cannot be serviced, e.g., in an error case, then the consolidated session is automatically recovered without the client is required to do that. The client then just needs to check the request and possibly repeat it in the same or in an amended form.

As reveals from a server side provided proxy user management component 23 the administrative workload at the server application is reduced significantly because the server application just needs to authenticate the proxy user provided by the inventional session control component 20 and not a plurality of single clients as it is the case in prior art.

Depending on the session implementation concept implemented within component 26 either only a single session can be managed per server application or if required by bandwidth needs a respective larger number of them can be created. As reveals clearly from the description in the drawing the clients communicate with the session control component 20 which acts as a proxy user in relation to the clients, and the same proxy user acts as a single client in relation to a server application. This inventional redistribution of user authentication and authorisation work handled by the session control component 20 results in that fewer resources are required within the operating system hosting the server application. More particularly, when one system process is allocated for implementing one single consolidated session, the number of operating system processes is decreased by the invention by a factor of n, if n is the number of clients issuing requests to this server application. Further, the administration work on the server side is strongly reduced to the work which is necessary to check the single proxy user defined by session control component 20.

Further, only an incremental effort is required when mapping additional single clients to an already existing session they should have access to, because the session is already existing and is already managed and maintained between session control component 20 and a respective server application. Thus, in summary instead of n-times m-sessions only m-sessions are needed to establish the communication between n-clients and m-server applications, wherein each client is allowed to communicate with each of the server applications.

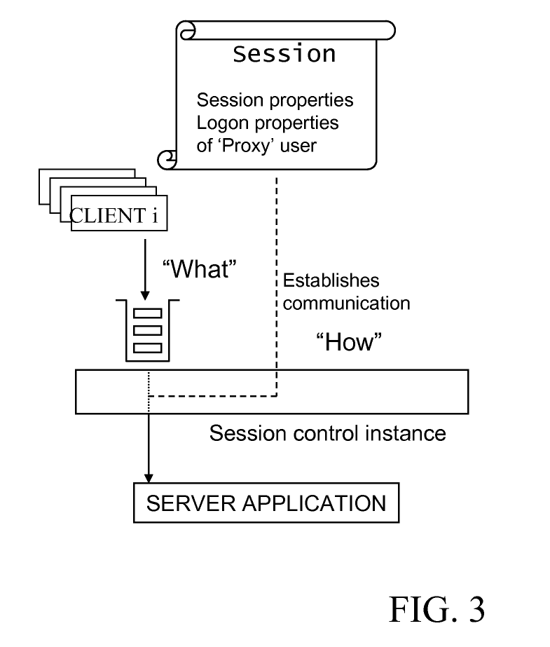

With further additional reference to FIG. 3 some additional logical aspects of the inventional “consolidated sessions” concept are given next below. Each of the incoming client requests specifies all attributes necessary for enabling the proxy user implemented within the inventional session control instance 20 to authenticate at the server application depicted below.

Preferably, those attributes are combined within a so-called session object “Session” and referenced as one entity by a symbolic name.

Those attributes include all information like server application address, additional connection data that can be used to control the server application's behaviour, a server application type to provide a common behaviour on the client-side for different kinds of servers, session timeout limits, user ID, passwords (readable or encrypted), enterprise names, etc., necessary to authenticate a requesting person and further clearly define for each of said users the allowed operations requested by a client request. The operations requested at a respective server application usually depend on a respective server application. Thus, for example a simple command followed by some command arguments (e.g. delete path_name/file) can be specified as well as numerous further statements (e.g. SQL statements).

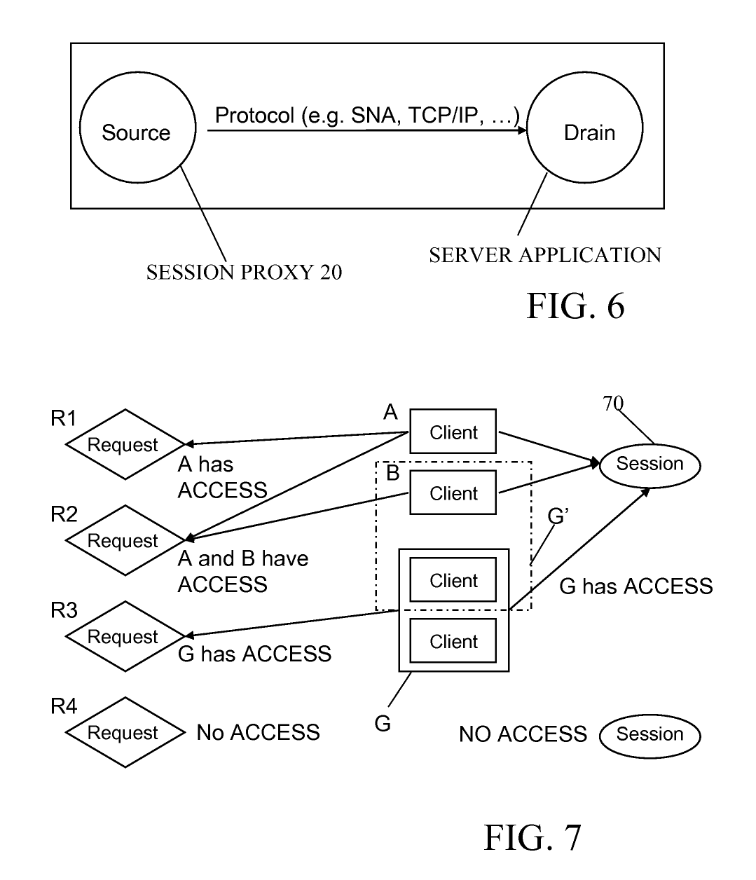

Further, each request specifies the server application name or the server application ID as for example required by any protocol (for example HTTP, SMA, TCPIP, etc.), see also FIG. 6 for reference. Thus, for each incoming requests a complete description of “who requests what from which server application” is given.

The session control component creates as many sessions as required by the number of requested server applications and creates a respective number of instances, processes, tasks, threads, etc. whatever is best suited by the operating system of the computer hosting the session control component 20. Here, a session control instance is shown which processes the client requests of a single consolidated session in serial order on a “first comes, first served”-bases. If hardware or software errors occur, then a session can be easily recovered by the session control component 20. This can be done automatically without any human interaction. Further, as already mentioned before, different consolidated sessions can be implemented for a single server application, for example in order to adapt for different respective session characteristics required. For example certain requests should be processed very quickly whereas others can be processed less quickly. Further, certain requests can be processed with a higher and others with a lower degree of security within the communication channel established by an individual consolidated session.

Further, the serialisation of the incoming requests can be implemented either within or without of the session control component as disclosed in here. This should be done according to the specific needs of the IT environment in question. The same is basically true with the administration of access rights which is depicted in FIG. 2 as a software component 24 within the session control component 20. This could also be implemented out of this component 20 and in particular preconnected to it.

Also, it is possible to implement a preconnected security tool, preconnected to the application server and communicating with the proxy user from session control component 20.

As reveals from FIG. 3 the clients can concentrate to the business critical question “what” they want to request from a certain server application, whereas the inventional session control component 20 can concentrate on the question “how” to establish the communication between client and server application. In particular this includes the function provided by the session control component 20 to automatically create a session, if none exists, under cover, i.e. implicitly and transparent for the client, so the clients are relieved from the burden to manage the sessions they use on their own.

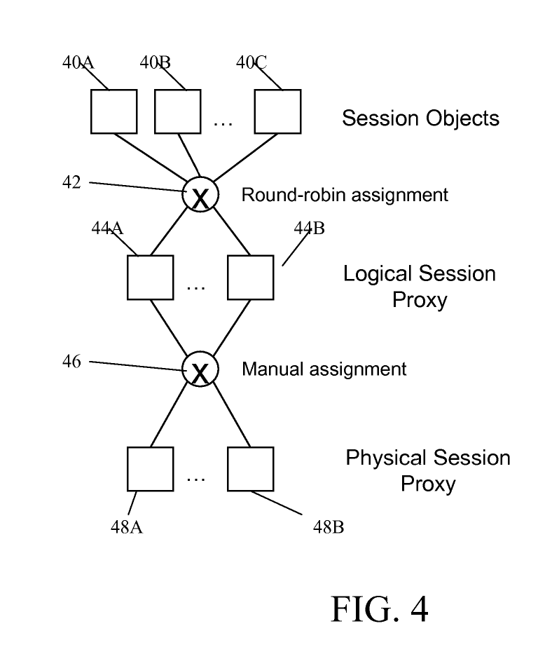

With further reference to FIG. 4 a separate preferred feature of the inventional method will be described as follows: According to this preferred implementational feature a session object is defined, which is depicted with reference signs 40A, 40B, 40C in FIG. 4. Such session object contains all attributes that are relevant to establish a session to a particular server application (see above). The session objects are referenced by the client requests. They are assigned to a particular logical session proxy. Further, a logical session proxy can represent a plurality of session objects. The logical session proxys are depicted with numerals 44A, 44B. Between session objects and logical session proxies can be implemented a round robin assignment or any other adequate assignment 42.

Further, within the session control component 20 (FIG. 2), each logical session proxy 44 is assigned to a particular physical session proxy 48A, 48B, for example by a manual assignment 46. This physical session proxy 48 is a physical task (process) that runs a specific session control instance as described before. Each of said physical tasks can represent a plurality of logical session proxies.

The separation of logical and physical session proxys provides higher robustness with respect to physical session proxy failures. While the logical session proxy remains constant for any given session object, the session control instance has the flexibility to select another, secondary (pre-defined) physical session proxy if the primary physical session proxy is unavailable.

There can be a 1:n relationship between physical session proxy and logical session proxies. With n>1, all requests to sessions represented by session objects mapped to n logical session proxys are serialized on the physical session proxy level. With n=1, only requests to sessions represented by session objects mapped to the one logical session proxy are serialized on the physical session proxy level. So this gives the administrator the flexibility to trade a minimum of resources (n>1) against the maximum performance (n=1).

Between physical session proxy 48 and logical session proxy a manual assignment 46 is proposed, which can be changed according to the current needs of the overall communication system. The session control instance as depicted with these details in FIG. 4 thus processes one request at a time as the requests are queued in a FIFO-order.

Further, the control instance—preferably the logical session proxy 44A, 44B detects whether a session does already exist, and if not it establishes a session according to the attributes given in the respective session object.

Further, this control instance implements control software for detecting when a session is broken. In this case it attends to repair the connection at the next request. A client will merely detect that a request failed in that case but is not responsible himself for recovering the session—this is the responsibility of the session control instance.

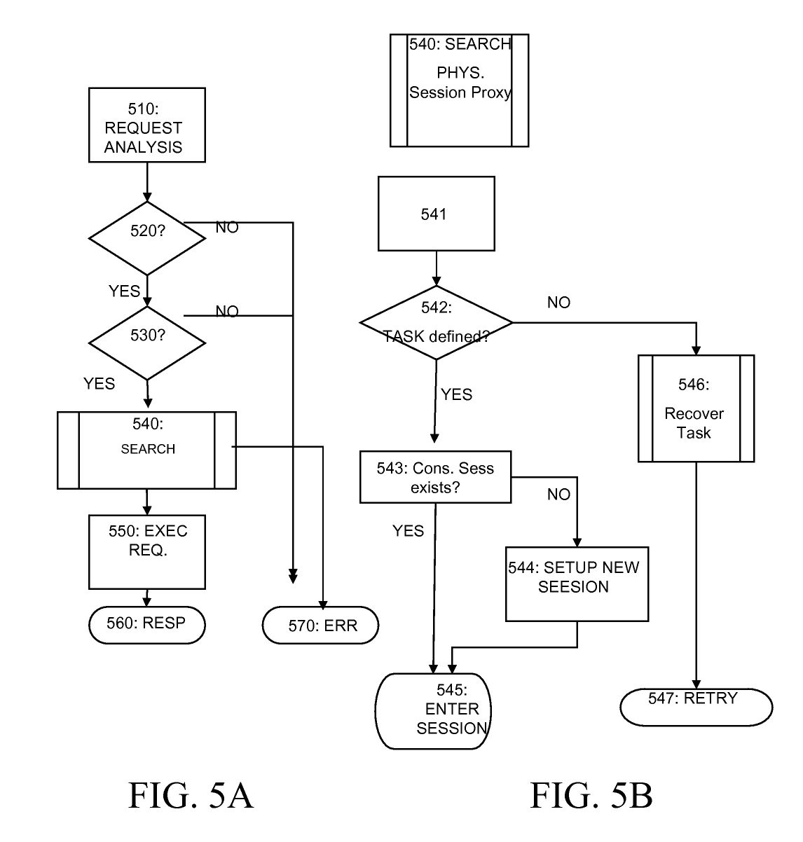

With additional reference to FIGS. 5A and 5B the control flow of the inventional method in a preferred embodiment thereof is described in more detail:

In a first step 510 a client request is evaluated at the session control component 20 in relation to the attributes “who requests what from where with which access rights”. For example in a file system administration a certain file system subtree can be requested to be deleted by a specific user with a specific delete command.

In a check 520 the component 20 reads those input attributes and performs a crosscheck in a user table maintained therein, which holds any access rights for any allowed applications for this particular user. It should be noted that this is a work which is in prior art done by the requested server application itself. In the NO-branch of check step 520 an error message is sent back to the requesting user in a step 570.

Otherwise, a second check step 530 is performed by the access authorisation management component 24 checking, if the specific command comprised of the request accompanied by the respective command arguments is allowed for the requesting user. In order to do that a similar lookup of the respective user access right tables is performed. In case of a negative check a similar error message 570 is sent to the requesting user. Otherwise, in a step 540 a search is performed by session control component 20 for the adequate physical session proxy for this request. Details of step 540 are depicted in FIG. 5B:

In a step 541 first, the adequate task, i.e., the physical session proxy, is searched for the request. In order to do that the request is associated with a request ID identifying the server application relevant for the request, and a lookup for an adequate physical session proxy 48 is performed as described before with reference to FIG. 4.

In more detail, the session control instance looks up the logical session proxy assigned to the said session. In the next step, the session control instance looks up the physical session proxy currently mapped to the logical session proxy. Check 542 is performed by checking if a task is already defined and available which is adequate for the incoming request. In case the task failed, the task is recovered in a step 546. Then in a subsequent step 547 the respective session—consolidated session—is not available and thus a retry is performed.

In case that check step 542 found an adequate task for accessing the requested server application, a next check step 543 checks if there is already a consolidated session present between session control component 20 and the requested server application. If this session exists, then in a step 545 this session is entered for the incoming request, i.e. the request is forwarded to the server application by putting the request into the pre-existing series of requests directed for this server application. Then, see back to FIG. 5A, if the sequence of requests is processed such that the current requests can be executed, this request is executed in step 550. The server application then generates a response to this request in a step 560 which is forwarded to the requesting client by using the same consolidated session as was used for the request itself. Of course, asynchronous variations thereof may be implemented, in which different sessions are used for request and respective response, wherein the control instance signals to the client that a response is present for a preceding client request having the respective client token.

With reference back to step 543, in the NO-case thereof, a new physical session is set up in a step 544 in order to enable the request to be directed to the server application. Then, also step 550 and 560 is carried out. When the new physical session is set up in step 544, the connection to the server application is built using the before-mentioned proxy-user implicitly and transparently to the client who originated the request.

With further reference to FIG. 6 some implementation details and variations for establishing a consolidated session according to the invention are described in more detail: basically for receiving the client requests and issuing responses to the requests one process or a plurality of them can be implemented. Further, the proxy user password is managed by the session proxy 20, preferably which acts as a source of requests in relation to the drain, which is the server application. Alternatively, the proxy user password could be also implemented and required as a part of the client request.

At the application server also one process or a plurality of them can be implemented. For example one process can be used for performing the YES-branches mentioned in FIG. 5, i.e. the regular workflow, whereas one or more processes can be used for implementing the NO-branches, i.e. the error treatment.

Further, the proxy user can either be authentified once and then accepted as long as no timeout is defined by the application server, or a repeating authentication check of an incoming request can be performed at the server. In the first case, a token is generated by the application server, which is used for further requests by the session control component 20. Further, the authentication component can either be part of the server application or can be implemented by a separate authentication tool which is connected between component 20 and the server application.

With further reference to FIG. 7 and special reference back to check step 520 in FIG. 5A the mapping between different clients to different consolidated sessions is described in more detail. FIG. 7 shows at the left margin incoming requests, which are processed by the session control component as described before with reference to FIG. 5. The logic depicted in FIG. 7 is best implemented within or in a pre-connected form to this session control component. First, an incoming request is analysed to yield the user (user ID and password) or software component which issued the request.

In FIG. 7 some different possibilities to map clients to a specific session are illustrated: in the upper case a client A is allowed to participate in a session 70. This is depicted in the upper portion of the figure. The same is true for a given client B. Further, a group G can be defined to comprise two different clients. This is depicted in the bottom part of the figure. This grouping can also be varied in order to include a second or further groups G′.

On the left side, particular requests R1 . . . R4 are listed that clients A and B, or the client group G are permitted to execute. Depending on the server application's capabilities or depending on naming schemes, it could be possible to treat R1 . . . R4 as classes of individual requests. So the granularity of request authorization can be fine or coarse depending on the concrete requirements.

It should be noted that the access rights of the proxy user in total must be sufficient in order to execute the commands defined in the incoming requests R1 . . . R4.

R4 for example is exemplarily shown to be not executable, as no client (neither A, B, nor group G) is allowed to do so. Thus, in summary depending of a concrete implementation of the security requirements either a specific or a more general allowance is provided to use a specific consolidated session. Also, either a specific or a more general allowance can be provided for the servicing of specific requests. Further, a general access denial for specific sessions or requests can be defined.

The present invention can be realized in hardware, software, or a combination of hardware and software. A session consolidation tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A method for managing client-server communication in an electronic network, wherein for multiple clients a respective client-related client authentication and authorization is required for accessing server applications, characterized by the steps of:
a) managing the client authentication data of a plurality of clients and authorization data for authorized accesses to said server applications in a session control component independent of said server applications,
b) receiving incoming client requests directed to access one of said server applications,
c) checking the authentication and/or authorization of said client requests,
d) maintaining a single Proxy-user in relation to a single server application, wherein said Proxy user represents a plurality of clients and their authorization for connecting to and for using said respective single server application,
e) operating a single session using said Proxy-user for a plurality of allowed client requests directed to an access to a respective same single server application,
f) processing said requests sequentially within said single session.

2. The method according to claim 1, wherein said single Proxy-user functionality is implemented by generating a logical session proxy part representing a plurality of N session objects, and a physical session proxy part associated therewith and running a session control instance which performs the requested server application accesses with respective resources provided by the Operating System of the hardware implementing the session control component.

3. The method according to claim 1, wherein multiple consolidated sessions are established to a single or to a plurality of application servers comprising different bandwidth capabilities or different security definitions.

4. The method according to claim 2, wherein to said session objects logical names are applied, which are selected semantically meaningful, and wherein a mapping of these logical names to Server application IDs is provided.

5. A computer system for managing client-server communication in an electronic network, wherein for multiple clients a respective client-related client authentication and authorization is required for accessing server applications, the system having:
a) a session control component for managing the client authentication data of a plurality of clients and authorization data for authorized accesses to said server applications independently of said server applications, and for maintaining a single Proxy-user functionality in relation to a single server application,
b) enqueuing means for processing said requests sequentially within a single session.

6. A computer program product in a computer readable medium for execution in a data processing system for managing client-server communication in an electronic network, wherein for multiple clients a respective client-related client authentication and authorization is required for accessing server applications, comprising a functional component for performing the steps of:
a) managing the client authentication data of a plurality of clients and authorization data for authorized accesses to said server applications in a session control component independent of said server applications,
b) receiving incoming client requests directed to access one of said server applications,
c) checking the authentication and/or authorization of said client requests,
d) maintaining a single Proxy-user in relation to a single server application, wherein said Proxy user represents a plurality of clients and their authorization for connecting to and for using said respective single server application,
e) operating a single session using said Proxy-user for a plurality of allowed client requests directed to an access to a respective same single server application,
f) processing said requests sequentially within said single session, when said computer program code portions are executed on a computer.

7. (canceled)

8. The system according to claim 5, wherein said single Proxy-user functionality is implemented by generating a logical session proxy part representing a plurality of N session objects, and a physical session proxy part associated therewith and running a session control instance which performs the requested server application accesses with respective resources provided by the Operating System of the hardware implementing the session control component.

9. The system according to claim 5, wherein multiple consolidated sessions are established to a single or to a plurality of application servers comprising different bandwidth capabilities or different security definitions.

10. The system according to claim 5, wherein to said session objects logical names are applied, which are selected semantically meaningful, and wherein a mapping of these logical names to Server application IDs is provided.

11. The product method according to claim 6, wherein said single Proxy-user functionality is implemented by generating a logical session proxy part representing a plurality of N session objects, and a physical session proxy part associated therewith and running a session control instance which performs the requested server application accesses with respective resources provided by the Operating System of the hardware implementing the session control component.

12. The product according to claim 6, wherein multiple consolidated sessions are established to a single or to a plurality of application servers comprising different bandwidth capabilities or different security definitions.

13. The product according to claim 6, wherein to said session objects logical names are applied, which are selected semantically meaningful, and wherein a mapping of these logical names to Server application IDs is provided.
